(19) United States
(12) Patent Application Publication
(10) Pub. No.: US 2025/0175963 A1
(43) Pub. Date: May 29, 2025

(54) METHOD, DEVICE AND COMPUTER REDABLE MEDIUM OF COMMUNICATION

(71) Applicant: NEC CORPORATION, Tokyo (JP)

(72) Inventors: Gang WANG, Beijing (CN); Yukai GAO, Beijing (CN)

(73) Assignee: NEC CORPORATION, Tokyo (JP)

(21) Appl. No.: 18/725,664

(22) PCT Filed: Dec. 31, 2021
(86) PCT No.: PCT/CN2021/143904

§ 371 Date: Jul. 2, 2024

(51) Int. Cl. H04W 72/044; H04B 7/06; H04W 72/232

(52) U.S. Cl. CPC H04W 72/046; H04B 7/06964; H04W 72/232

(57) ABSTRACT

Embodiments of the present disclosure provide methods, devices and computer readable media of communication. The method comprises receiving, at a terminal device and via a first serving cell, DCI indicating a TCI state; determining, based on the reception of the DCI, that a first set of reference signals for beam failure detection in the first serving cell is reconfigured, the TCI state indicating the first set of reference signals; and terminating, based on the determination, a first beam failure detection and recovery procedure for the first serving cell. In this way, a reduced latency and an improved efficiency for BFR are attained.

### TECHNICAL FIELD

Embodiments of the present disclosure generally relate to the field of telecommunication, and in particular, to methods, devices and computer readable media of communication for beam failure recovery (BFR).

### BACKGROUND

Generally, a beam failure may occur when quality of one or more transmitter and receiver beam pairs of an associated control channel falls low enough. A BFR mechanism to recover from a beam failure may be triggered when the beam failure occurs. Currently, a beam failure detection and recovery procedure may be individually performed for each component carrier (CC). This may cause a large signaling overhead.

### SUMMARY

In general, example embodiments of the present disclosure provide method, device and computer readable medium of communication for BFR.

In a first aspect, there is provided a method of communication. The method comprises: receiving, at a terminal device and via a first serving cell, downlink control information (DCI) indicating a transmission configuration indication (TCI) state: determining, based on the reception of the DCI, that a first set of reference signals for beam failure detection in the first serving cell is reconfigured, the TCI state indicating the first set of reference signals; and terminating, based on the determination, a first beam failure detection and recovery procedure for the first serving cell.

In a second aspect, there is provided a method of communication. The method comprises: transmitting, at a network device and via a first serving cell, DCI indicating a TCI state; and terminating, based on the transmission of the DCI, a first beam failure detection and recovery procedure for the first serving cell.

In a third aspect, there is provided a terminal device. The terminal device comprises a processor configured to perform the method according to the first aspect of the present disclosure.

In a fourth aspect, there is provided a network device. The network device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane (UP) protocol stack in which some embodiments of the present disclosure can be implemented:

FIG. 1C illustrates a schematic diagram of a control plane (CP) protocol stack in which some embodiments of the present disclosure can be implemented;

FIG. 2 illustrates a schematic diagram illustrating a process for communication according to embodiments of the present disclosure:

FIG. 3 illustrates a flowchart of an example method of communication implemented at a terminal device in accordance with some embodiments of the present disclosure:

FIG. 4 illustrates a flowchart of an example method of communication implemented at a network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability: It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as “at least one embodiment.” The term ‘another embodiment’ is to be read as “at least one other embodiment.” The terms “first,” “second,” and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the terms ‘BFR’, ‘beam failure recovery’, ‘link recovery’, ‘beam failure recovery request’, or ‘link recovery request may be used interchangeably. The term ‘cell’, ‘beam’, ‘CC’, ‘beam failure detection (BFD) reference signal (RS) set’, or ‘transmission reception point (TRP)’ may be used interchangeably.

Generally, a BFR mechanism on a terminal device side usually includes at least one of the following operations: BFD, identification of a new candidate beam, transmission of a BFR request and monitoring a response for the BFR request from a network device. The BFD is performed based on measurements on a set of RSs. If a beam failure occurs, a terminal device may start or restart a beam failure detection timer and increment a counter BFI_COUNTER configured for counting a beam failure instance.

If BFI_COUNTER is greater than or equal to a beam failure instance maximum count, a BFR procedure may be triggered. Specifically, if the serving cell is a secondary cell (SCell), the terminal device may trigger a BFR for this serving cell. If the serving cell is a special cell (SpCell), the terminal device may initiate a random access (RA) procedure on the SpCell.

If the serving cell is SpCell and the RA procedure initiated for SpCell is successfully completed, the terminal device may set the counter BFI_COUNTER to 0, stop a beam failure recovery timer if configured, and consider the BFR procedure successfully completed.

If the serving cell is SCell, and a physical downlink control channel (PDCCH) addressed to cell-radio network temporary identity (C-RNTI) indicating uplink grant for a new transmission is received for a hybrid automatic repeat request (HARQ) process used for the transmission of a BFR medium access control (MAC) control element (CE) or truncated BFR MAC CE which contains BFR information of this serving cell, the terminal device may set the counter BFI_COUNTER to 0, and consider the BFR procedure successfully completed and cancel all the triggered BFRs for this serving cell.

If the beam failure detection timer expires, or if the beam failure detection timer, the beam failure instance maximum count or any of the RSs used for BFD is reconfigured by upper layers associated with this serving cell, the counter BFI_COUNTER may be set to 0.

As mentioned above, the BFR procedure may be individually performed for each CC or cell, which may cause a large signaling overhead.

Recently, a unified transmission configuration indication (TCI) framework is introduced. In the framework, a TCI field in downlink control information (DCI) for beam indication is used to indicate a TCI state for downlink (DL) or uplink (UL) or both. Further, a common TCI state identity (ID) update and activation for carrier aggregation (CA) is introduced, and then single DCI may be used to update TCI states of multiple CCs. The TCI state may indicate a set of RSs for BFD.

In view of this, embodiments of the present disclosure provide a solution of BFR in combination with the unified TCI framework and/or the common TCI state ID update and activation for CA. In the solution, in response to receiving DCI indicating a TCI state via a serving cell, a terminal device determines that a set of RSs for BFD in the serving cell is reconfigured or configured or updated or reset. Based on the determination, the terminal device terminates a beam failure detection and recovery procedure (BFD and/or BFR) for the serving cell. In this way, a latency of a BFR procedure for a serving cell may be reduced and signaling overhead may be saved.

Principles and implementations of the present disclosure will be described in detail below with reference to the figures.

### Example of Communication Network

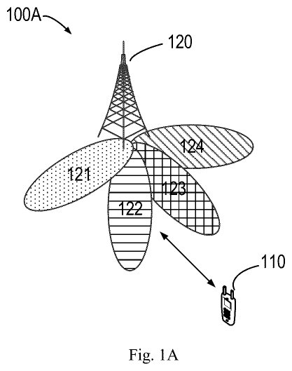

FIG. 1A illustrates an example communication network 100A in which embodiments of the present disclosure can be implemented. As shown in FIG. 1, the network 100A includes a terminal device 110 and a network device 120 serving the terminal device 110. The network device 120 provides beams 121, 122, 123 and 124 (also referred to as serving cells 121, 122, 123 and 124 herein) for communication with the terminal device 110.

It is to be understood that the number of network devices, terminal devices and serving cells as shown in FIG. 1 is only for the purpose of illustration without suggesting any limitations. The network 100A may include any suitable number of network devices, terminal devices and serving cells adapted for implementing embodiments of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 is referred to as UL communication, while communication in a reverse direction from the network device 120 towards the terminal device 110 is referred to as DL communication. The terminal device 110 can move amongst the serving cells of the network device 120 and possibly other network devices. In UL communication, the terminal device 110 may transmit UL data and control information to the network device 120 via a UL channel. In DL communication, the network device 120 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity: As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In some embodiments, a beam failure may occur if the network device 120 is no longer able to reach the terminal device 110 via a downlink control channel (such as, PDCCH) due to incorrect adjustment of the beams, blockage effect, movement of the terminal device, or some other reasons. For example, the terminal device 110 may detect this situation by estimating the quality of a hypothetical PDCCH reception transmitted over a beam that the network device 110 would use to reach the terminal device 130. To perform BFD, the terminal device 110 may estimate the quality of a hypothetical PDCCH reception based on reception of a certain reference signal (RS). In the following text, this RS may also be referred to as “BFD RS” or “RS for BFD”. Examples of the BFD RS may include but not limited to periodic channel state information-reference signal (CSI-RS), synchronization signal/physical broadcast channel block (SS/PBCH block), or a combination thereof.

In some embodiments, when the quality of the hypothetical PDCCH reception for a beam is worse than a threshold, the terminal device 110 may determine that the beam failed. Then a counter configured for BFD for the beam is incremented. If the count of the counter is greater than or equal to a beam failure instance maximum count, a BFR procedure may be triggered for the beam. Before the counter is reset to 0, one or more BFR procedures may be triggered for the beam as more beam failure instances may occur. Generally, one or more BFR procedures may be triggered for each beam or serving cell failed.

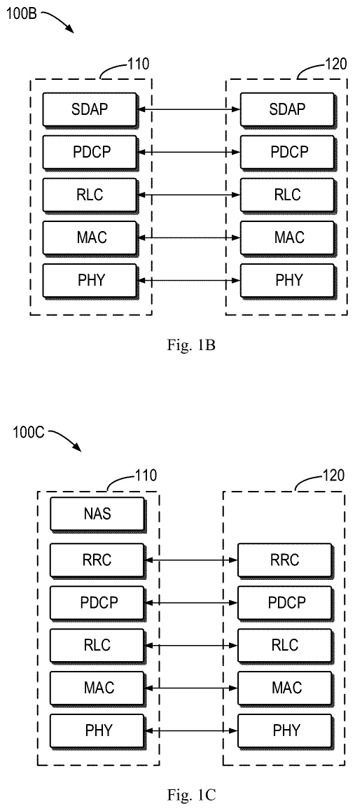

In some embodiments, the network device 120 may transmit DCI (e.g. DCI formats 1_1/1_2 with and without DL assignment) to indicate a TCI state (also referred to as a TCI-state herein). Embodiments of the present disclosure provide a solution for BFR considering the TCI state. The detailed description will be given in connection with FIG. 2.

### Example Implementation of BFR for CC

FIG. 2 illustrates a schematic diagram illustrating a process 200 for communication according to embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the network device 120 transmits 210 DCI indicating a TCI state to the terminal device 110 via any of the serving cells 121, 122, 123 and 124. In this example, assuming that the network device 120 transmits the DCI via the serving cell 121 (for convenience, also referred to as a first serving cell herein). In some embodiments, the serving cell 121 may be a SpCell. In some embodiments, the serving cell 121 may be a SCell. The DCI indicating the TCI state may also be called as a DCI-based beam indication.

In some embodiments, the TCI state may indicate a set of RSs for BFD (also referred to as a first set of RSs for BFD herein) in the serving cell 121. In some embodiments, the TCI state may also indicate respective sets of RSs for BFD (also referred to as second sets of RSs for BFD herein) in the serving cells 122, 123 and 124. In some embodiments, the sets of RSs for BFD in the serving cells 121, 122, 123 and 124 may be different from each other. In some embodiments, the serving cells 121, 122, 123 and 124 may share a common set of BFD RSS.

In some embodiments, the TCI state may indicate a set of RSs for downlink channel monitoring such as PDCCH monitoring.

As the DCI is received via the serving cell 121, the terminal device 110 determines 220 that a set of RSs for BFD in the serving cell 121 is reconfigured. In other words, on which serving cell the TCI state is received, it is determined which serving cell's BFD RS set is reconfigured.

In some embodiments where the TCI state indicates the set of RSs for BFD in the serving cell 121, the terminal device 110 may directly determine the set of RSs for BFD in the serving cell 121 based on the indication from the TCI state. In some embodiments, the terminal device 110 may be configured, for each bandwith part (BWP) of a serving cell, with a set of BFD RSs (e.g. q₀) by RRC signaling (e.g. failureDetectionResourcesToAddModList field). In some embodiments, the terminal device 110 may determine that the set of RSs for BFD in the serving cell 121 is reconfigured if the set of RSs for BFD indicated by the TCI state is different from the configured set of BFD RSs. In some embodiments, the terminal device 110 may determine that the set of RSs for BFD in the serving cell 121 is reconfigured if the set of RSs for BFD indicated by the TCI state is different from that indicated by a previous TCI state.

In some embodiments where the TCI state indicates a set of RSs for downlink channel monitoring such as PDCCH monitoring, the terminal device 110 may determine the set of RSs for BFD in the serving cell 121 to include the set of RSs for downlink channel monitoring indicated by the TCI state if the terminal device 110 is not configured with a set of BFD RSs by RRC signaling (e.g. failureDetectionResourcesToAddModList field) for a BWP of the serving cell. For example, the terminal device 110 may determine the set of BFD RSs to include periodic CSI-RS resource configuration indexes with same values as the RS indexes in the RS sets indicated by TCI-State for respective CORESETs that the terminal device 110 uses for monitoring PDCCH. That is, the terminal device 110 reuse the set of RSs indicated by TCI-state for monitoring PDCCH or for CORESET as a set of BFD RSs if the terminal device 110 is not configured with a set of BFD RSs explicitly by failureDetectionResourcesToAddModList for a BWP of the serving cell.

In some embodiments, the determination may be performed by a lower layer of the terminal device 110. In some embodiments, based on the DCI, a PHY layer of the terminal device 110 may determine that the set of RSs for BFD in the serving cell 121 is reconfigured. For example, the PHY layer may determine that the set of RSs for BFD in the serving cell 121 is reconfigured if the activated (also referred to as applied or indicated herein) TCI state (e.g. the source RS for qcl-TypeD of the indicated TCI state) or the activated BFD RS is different from previous activated TCI state or activated BFD RS. As another example, the PHY layer may determine that the set of RSs for BFD in the serving cell 121 is reconfigured if the activated TCI state or BFD RS is different from the TCI state or BFD RS based on which beam failure is detected on the current cell. In some embodiments, the terminal device 110 may transmit, from the PHY layer to a MAC layer of the terminal device 110, an indication (for convenience, also referred to as a first indication herein) indicating that the set of RSs for BFD in the serving cell 121 is reconfigured. In other words, the PHY layer of the terminal device 110 may indicate the MAC layer of the terminal device 110 that the set of RSs for BFD in the serving cell 121 is reconfigured.

In some embodiments, the terminal device 110 may transmit the first indication in response to receiving the DCI. In some embodiments, the terminal device 110 may transmit the first indication in response to transmitting an acknowledgement (ACK) for the reception of the DCI. In some embodiments, the terminal device 110 may transmit the first indication in response to utilizing the set of RSs for BFD in the serving cell 121. Of course, any other suitable timing is also feasible to be used for the transmission of the first indication.

In some embodiments, the determination may be performed by an upper layer of the terminal device 110. In some embodiments, the PHY layer of the terminal device 110 may transmit, to the MAC layer of the terminal device 110, information (for convenience, also referred to as first information herein) of the set of RSs for BFD in the serving cell 121. Based on the first information of the set of RSs for BFD in the serving cell 121, the MAC layer may determine that the set of RSs for BFD in the serving cell 121 is reconfigured. In some embodiments, the first information may comprise an index of at least one BFD RS for the serving cell 121. In some embodiments, the first information may comprise the TCI state or an index of BFD RS configuration or an index of BFD RS for the serving cell 121. It is to be understood that the first information may take any other suitable forms. For example, the MAC layer may determine that the set of RSs for BFD in the serving cell 121 is reconfigured if the activated TCI state (e.g. the source RS for qcl-TypeD of the indicated TCI state) or the activated BFD RS is different from previous activated TCI state or activated BFD RS. As another example, the MAC layer may determine that the set of RSs for BFD in the serving cell 121 is reconfigured if the activated TCI state or BFD RS is different from the TCI state or BFD RS based on which beam failure is detected on the current cell. In some embodiments, the MAC layer may store the information about activated TCI state or activated BFD RS for the determining of reconfiguration.

In some embodiments, the terminal device 110 may transmit the first information in response to receiving the DCI. In some embodiments, the terminal device 110 may transmit the first information in response to transmitting an ACK for the reception of the DCI. In some embodiments, the terminal device 110 may transmit the first information in response to utilizing the set of RSs for BFD in the serving cell 121. Of course, any other suitable timing is also feasible to be used for the transmission of the first information.

With reference to FIG. 2, in some embodiments, the network device 120 may transmit 225, to the terminal device 110, an indication (for convenience, also referred to as a third indication herein) indicating whether the PHY layer or MAC layer of the terminal device 110 determines that the set of RSs for BFD in the serving cell 121 is reconfigured. Based on the third indication, the terminal device 110 may perform the determination accordingly.

Upon determination that the set of RSs for BFD in the serving cell 121 is reconfigured, the terminal device 110 terminates 230 a beam failure detection and recovery procedure (for convenience, also referred to as a first beam failure detection and recovery procedure herein) for the serving cell 121. In some embodiments, the terminal device 110 may set a counter configured for BFD for the serving cell 121 to zero. In some embodiments, the terminal device 110 may cancel at least one BFR procedure triggered for the serving cell 121. In some embodiments, the terminal device 110 may cancel a transmission of at least one SR for the at least one BFR procedure for the serving cell 121. In some embodiments, the terminal device 110 may cancel all BFR procedures triggered for the serving cell 121. In some embodiments, the terminal device 110 may cancel transmissions of all SRs for all the BFR procedures. In some embodiments, the terminal device 110 may cancel a reception of at least one BFR response (BFRR) to the at least one BFR procedure for the serving cell 121. In some embodiments, the terminal device 110 may consider a set of BFR procedures successfully completed for the serving cell 121. In some embodiments, the terminal device 110 may consider a set of RA procedures for the serving cell 121 (e.g. RA procedures triggered in response to a detection of beam failure, especially for SpCell) successfully completed.

In another example, assuming that the network device 120 transmits the DCI via a serving cell (for example, the serving cell 122). The DCI may indicate that the TCI state is for another serving cell (for example, the serving cell 121). For example, a carrier indicator field in the DCI may be used to indicate that the TCI state is for the serving cell 121. That is, the TCI state for the serving cell 121 is received via the serving cell 122 with the DCI indicating the TCI state for the serving cell 121. As the DCI indicates the TCI state for the serving cell 121, the terminal device 110 determines 220 that a set of RSs for BFD in the serving cell 121 is reconfigured. In this case, the terminal device 110 may terminate all the beam failure detection and recovery procedures triggered for the serving cell 121. The termination for the serving cell 121 is similar with that described in connection with reference sign 230, and thus is not repeated here for concise.

In this way, a beam failure detection and recovery procedure may be early terminated, and signaling overhead may be significantly saved.

### Example Implementation of BFR for CA

Still with reference to FIG. 2, the terminal device 110 may determine 240 whether a common TCI state ID update and activation for CA is configured (also referred to as a common TCI state ID update, a common TCI state update, a common TCI ID update). For example, a common TCI state ID update and activation for CA is configured means that, if a list of RSs are configured for one cell and no list of RSs are configured to other cells (e.g. cells in one cell group), the other cells may use the list of RSs of the one cell. As another example, a common TCI state ID update and activation for CA is configured means that, for one cell, a list of RSs are configured, and an reference to one or multiple RSs in this list is configured for another cell (e.g. cell in one cell group).

Based on this configuration of the common TCI state ID update and activation for CA, the terminal device 110 may decide to terminate one or multiple beam failure detection and recovery procedures for one or more CCs. Some example embodiments will be described in connection with Embodiments 1 and 2.

### Embodiment 1

In this embodiment, upon reception of the DCI via the serving cell 121, the terminal device 110 may determine that a set of RSs for BFD in the serving cell 121 is reconfigured and terminate a beam failure detection and recovery procedure for the serving cell 121, as described above in connection with reference signs 210, 220, 225 and 230. In addition, upon reception of the DCI via the serving cell 121, the terminal device 110 may determine whether the common TCI state ID update and activation for CA is configured. If the common TCI state ID update and activation for CA is not configured, the process ends.

If the common TCI state ID update and activation for CA is configured, the terminal device 110 may determine that a set of RSs (for convenience, also referred to as a second set of RSs herein) for BFD in each of other serving cells (in this example, the serving cells 122, 123 and 124) is also reconfigured. In some embodiments, the serving cells 122, 123 and 124 may share a common set of RSs for BFD. In some embodiments, the serving cells 122, 123 and 124 may have separate sets of RSs for BFD.

In some embodiments where the TCI state indicates the set of RSs for BFD in the serving cells 122, 123 and 124, the terminal device 110 may directly determine the set of RSs for BFD in the serving cells 122, 123 and 124 based on the indication from the TCI state.

In some embodiments where the TCI state indicates a set of RSs for downlink channel monitoring such as PDCCH monitoring, the terminal device 110 may determine the set of RSs for BFD in the serving cells 122, 123 and 124 to include the set of RSs for downlink channel monitoring indicated by the TCI state if the terminal device 110 is not configured with a set of BFD RSs by failureDetectionResources To AddModList for a BWP of the serving cells 122, 123 and 124. For example, the terminal device 110 may determine the set of BFD RSs to include periodic CSI-RS resource configuration indexes with same values as the RS indexes in the RS sets indicated by TCI-State for respective CORESETs that the terminal device 110 uses for monitoring PDCCH. That is, the terminal device 110 reuse the RS indicated by TCI-state for monitoring PDCCH or for CORESET as BFD RS if the terminal device 110 is not configured with a set of BFD RSS explicitly by failureDetection Resources ToAddModList for a BWP of the serving cells 122, 123 and 124.

In some embodiments, a RRC layer of the terminal device 110 may transmit, to the PHY layer of the terminal device 110, the configuration of the common TCI state ID update and activation for CA. Based on the configuration of the common TCI state ID update and activation for CA and the DCI, the PHY layer of the terminal device 110 may determine that a set of RSs for BFD in each of the serving cells 122, 123 and 124 is reconfigured. In some embodiments, the PHY layer may transmit a set of indications (for convenience, also referred to as a set of second indications herein) to the MAC layer. In some embodiments, an indication in the set of indications indicates that a set of RSs for BFD in corresponding one of the serving cells 122, 123 and 124 is reconfigured. That is, separate indications are provided for the serving cells. In some embodiments, the set of indications may comprise a single indication that indicates that a set of RSs for BFD in each of the serving cells 122, 123 and 124 is reconfigured. In some embodiments, the single indication may comprise a set of identities for the serving cells 122, 123 and 124, i.e., a list of identities for the serving cells 122, 123 and 124.

In some embodiments, the terminal device 110 may transmit the set of second indications in response to receiving the DCI. In some embodiments, the terminal device 110 may transmit the set of second indications in response to transmitting an ACK for the reception of the DCI. In some embodiments, the terminal device 110 may transmit the set of second indications in response to utilizing the set of RSs for BFD in the serving cells 122, 123 and 124. Of course, any other suitable timing is also feasible to be used for the transmission of the set of second indications.

In some embodiments, the PHY layer of the terminal device 110 may transmit, to the MAC layer of the terminal device 110, information (for convenience, also referred to as second information herein) of the set of RSs for BFD in the serving cells 122, 123 and 124. The RRC layer of the terminal device 110 may transmit, to the MAC layer of the terminal device 110, the configuration of the common TCI state ID update and activation for CA. Based on the configuration of the common TCI state ID update and activation for CA and the second information of the set of RSs for BFD in the serving cells 122, 123 and 124, the MAC layer of the terminal device 110 may determine that the set of RSs for BFD in each of the serving cells 122, 123 and 124 is reconfigured.

In some embodiments, the terminal device 110 may transmit the second information in response to receiving the DCI. In some embodiments, the terminal device 110 may transmit the second information in response to transmitting an ACK for the reception of the DCI. In some embodiments, the terminal device 110 may transmit the second information in response to utilizing the set of RSs for BFD in the serving cells 122, 123 and 124. Of course, any other suitable timing is also feasible to be used for the transmission of the second information.

Upon determination that the set of RSs for BFD in each of the serving cells 122, 123 and 124 is reconfigured, the terminal device 110 may terminate 250 a set of beam failure and recovery procedures for the serving cells 122, 123 and 124. In other words, the terminal device 110 may terminate all the beam failure and recovery procedures triggered for the serving cells 122, 123 and 124. The termination for each of the serving cells 122, 123 and 124 is similar with that for the serving cell 121 as described in connection with reference sign 230, and thus is not repeated here for concise.

In this way, the beam failure detection and recovery procedures for all serving cells may be early terminated and the signaling overhead may be further reduced.

### Embodiment 2

This embodiment is a modification of Embodiment 1.

In this embodiment, upon reception of the DCI via the serving cell 121, the terminal device 110 may determine whether the common TCI state ID update and activation for CA is configured. If the common TCI state ID update and activation for CA is not configured, the terminal device 110 may determine that a set of RSs in the serving cell 121 is reconfigured. The terminal device 110 may terminate a beam failure detection and recovery procedure for the serving cell 121 as described above in connection with reference sign 230.

If the common TCI state ID update and activation for CA is configured, the terminal device 110 may determine that a set of RSs for BFD in all serving cells 121, 122, 123 and 124 is reconfigured. In some embodiments, the serving cells 121, 122, 123 and 124 may share a common set of RSs for BFD. In some embodiments, the serving cells 121, 122, 123 and 124 may have separate sets of RSs for BFD.

In some embodiments where the TCI state indicates the set of RSs for BFD in the serving cell 121, 122, 123 and 124, the terminal device 110 may directly determine the set of RSs for BFD in the the serving cell 121, 122, 123 and 124 based on the indication from the TCI state. In some embodiments, the terminal device 110 may be configured, for each BWP of a serving cell, with a set of BFD RSS (e.g. q₀) by failureDetectionResourcesToAddModList field. In some embodiments, the terminal device 110 may determine that the set of RSs for BFD in the the serving cell 121, 122, 123 and 124 is reconfigured if the set of RSs for BFD indicated by the TCI state is different from the configured set of BFD RSs. In some embodiments, the terminal device 110 may determine that the set of RSs for BFD in the serving cell 121, 122, 123 and 124 is reconfigured if the set of RSs for BFD indicated by the TCI state is different from that indicated by a previous TCI state.

In some embodiments where the TCI state indicates a set of RSs for downlink channel monitoring such as PDCCH monitoring, the terminal device 110 may determine the set of RSs for BFD in the serving cell 121, 122, 123 and 124 to include the set of RSs for downlink channel monitoring indicated by the TCI state if the terminal device 110 is not configured with a set of BFD RSs by failureDetectionResources To AddModList for a BWP of each of the serving cell 121, 122, 123 and 124. For example, the terminal device 110 may determine the set of BFD RSs to include periodic CSI-RS resource configuration indexes with same values as the RS indexes in the RS sets indicated by TCI-State for respective CORESETs that the terminal device 110 uses for monitoring PDCCH. That is, the terminal device 110 reuse the set of RSs indicated by TCI-state for monitoring PDCCH or for CORESET as a set of BFD RSs if the terminal device 110 is not configured with a set of BFD RSs explicitly by failureDetectionResourcesToAddModList for a BWP of each of the serving cell 121, 122, 123 and 124.

In this case, the terminal device 110 may terminate all the beam failure detection and recovery procedures triggered for all the serving cells 121, 122, 123 and 124. The termination for each of the serving cells 121, 122, 123 and 124 is similar with that described in connection with reference sign 230, and thus is not repeated here for concise.

In this way, the beam failure detection and recovery procedures for all serving cells may also be early terminated and the signaling overhead may also be further reduced.

Still with reference to FIG. 2, upon transmission of the DCI via the serving cell 121, the network device 120 accordingly terminates 260 the beam failure detection and recovery procedure for the serving cell 121. In some embodiments, the network device 120 may cancel at least one BFR procedure triggered for the serving cell 121. In some embodiments, the network device 120 may cancel a reception of at least one SR for the at least one BFR procedure. In some embodiments, the network device 120 may cancel a transmission of at least one BFRR to the at least one BFR procedure. In some embodiments, the network device 120 may consider a set of BFR procedures successfully completed. In some embodiments, the network device 120 may consider a set of RA procedures successfully completed.

In some embodiments, the network device 120 may determine 270 whether the common TCI state ID update and activation for CA is configured. If the common TCI state ID update and activation for CA is configured, the network device 120 may also terminates 280 the beam failure detection and recovery procedures for the serving cells 122, 123 and 124. The termination for each of the serving cells 122, 123 and 124 is similar with that described in connection with reference sign 260, and thus is not repeated here for concise.

In some embodiments, upon transmission of the DCI via the serving cell 121, the network device 120 may determine whether the common TCI state ID update and activation for CA is configured. If the common TCI state ID update and activation for CA is not configured, the network device 120 may terminates the beam failure detection and recovery procedure for the serving cell 121. If the common TCI state ID update and activation for CA is configured, the network device 120 may terminate the beam failure detection and recovery procedures for all the serving cells 121, 122, 123 and 124. The termination for each of the serving cells 121, 122, 123 and 124 is similar with that described in connection with reference sign 260, and thus is not repeated here for concise.

So far, the solution of BFR according to embodiments of the present disclosure is described. With this solution, a latency of a BFR procedure for a serving cell may be reduced and signaling overhead may be saved.

### Example Implementation of Methods

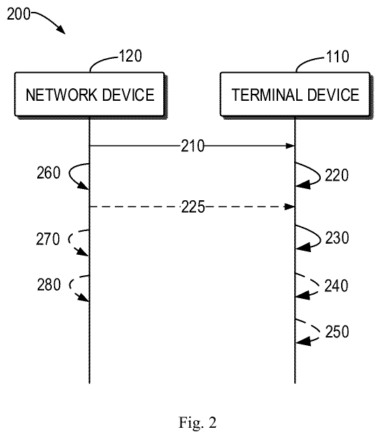

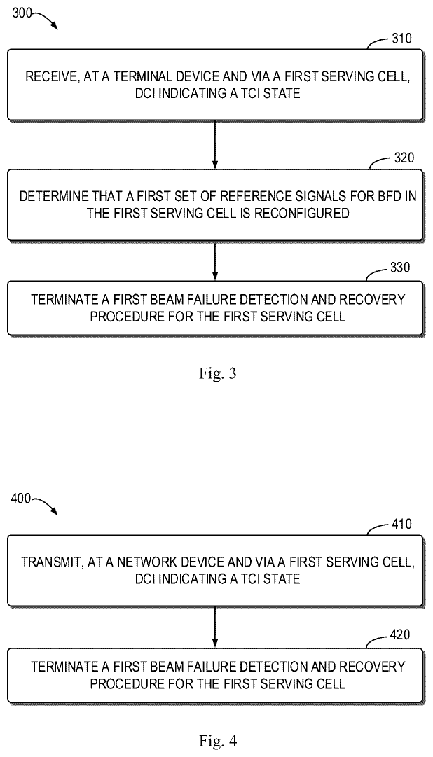

Correspondingly, embodiments of the present disclosure also provide methods and devices of communication. This will be described below in connection with FIGS. 3 and 4.

FIG. 3 illustrates a flowchart of an example method 300 of communication implemented at a terminal device in accordance with some embodiments of the present disclosure. The method 300 can be implemented at the terminal device 110 shown in FIG. 1. For the purpose of discussion, the method 300 will be described with reference to FIG. 1. It is to be understood that the method 300 may include additional acts not shown and/or may omit some shown acts, and the scope of the present disclosure is not limited in this regard.

At block 310, the terminal device 110 receives, via a first serving cell (for example, the serving cell 121), DCI indicating a TCI state.

At block 320, the terminal device 110 determines, based on the DCI, that a first set of RSs for BFD in the first serving cell is reconfigured. In some embodiments, if the first set of RSs BFD in the first serving cell is not configured for the terminal device 110, the terminal device 110 may determine the first set of RSs to include a set of RSs for downlink channel monitoring indicated by the TCI state.

In some embodiments, the terminal device 110 may determine, by a PHY layer of the terminal device 110 and based on the DCI, that the first set of RSs for BFD in the first serving cell is reconfigured. Then the terminal device 110 may transmit, from the PHY layer to a MAC layer of the terminal device 110, a first indication indicating that the first set of RSs for BFD in the first serving cell is reconfigured. In some embodiments, the terminal device 110 may transmit the first indication in response to at least one of the following: receiving the DCI: transmitting an acknowledgement for the reception of the DCI: or utilizing the first set of RSs for BFD in the first serving cell.

In some embodiments, the terminal device 110 may transmit, from a PHY layer of the terminal device 110 to a MAC layer of the terminal device 110, first information of the first set of RSs for BFD. Then the terminal device 110 may determine, by the MAC layer and based on the first information, that the first set of RSs for BFD in the first serving cell is reconfigured. In some embodiments, the terminal device 110 may transmit the first information in response to at least one of the following: receiving the DCI: transmitting an acknowledgement for the reception of the DCI: or utilizing the first set of RSs for BFD in the first serving cell.

In some embodiments, the terminal device 110 may receive an indication indicating whether the determination is performed by the PHY layer or the MAC layer of the terminal device 110.

At block 330, the terminal device 110 terminates, based on the determination, a first beam failure detection and recovery procedure for the first serving cell. In some embodiments, the terminal device 110 may terminate the first beam failure detection and recovery procedure by at least one of the following: setting a counter configured for BFD for the first serving cell to zero: cancelling at least one BFR procedure triggered for the first serving cell: cancelling a transmission of at least one SR for the at least one BFR procedure: cancelling a reception of at least one BFRR to the at least one BFR procedure: considering a set of BFR procedures successfully completed: or considering a set of RA procedures successfully completed.

In some embodiments, the terminal device 110 may determine whether a common TCI state ID update and activation for CA is configured for the terminal device 110. If the common TCI state ID update and activation for CA is configured, the terminal device 110 may determine that a second set of RSs for BFD in a set of second serving cells (for example, the serving cells 122, 123 and 124) is reconfigured. Then the terminal device 110 may terminate a set of second beam failure detection and recovery procedures for the set of second serving cells.

In some embodiments, if the second set of RSs for BFD in the set of second serving cells is not configured for the terminal device 110, the terminal device 110 may determine the second set of RSs to include a set of RSs for downlink channel monitoring indicated by the TCI state.

In some embodiments, the terminal device 110 may determine, by a PHY layer of the terminal device 110 and based on the DCI and the configuration of the common TCI state ID update and activation for CA from a RRC layer of the terminal device 110, that the second set of RSs for BFD in the set of second serving cells is reconfigured. Then the terminal device 110 may transmit, from the PHY layer to a MAC layer of the terminal device 110, a set of second indications indicating that the second set of RSs for BFD in the set of second serving cells is reconfigured. In some embodiments, the set of second indications may comprise a second indication, the second indication comprising a set of identities for the set of second serving cells. In some embodiments, the terminal device 110 may transmit the set of second indications in response to at least one of the following: receiving the DCI: transmitting an acknowledgement for the reception of the DCI: or utilizing the second set of RSs for BFD in the set of second serving cells.

In some embodiments, the terminal device 110 may transmit, from a PHY layer of the terminal device 110 to a MAC layer of the terminal device 110, second information of the second set of RSs for BFD. Then the terminal device 110 may determine, by the MAC layer and based on the second information and the configuration of the common TCI state ID update and activation for CA from a RRC layer of the terminal device 110, that the second set of RSs for BFD in the set of second serving cells is reconfigured. In some embodiments, the terminal device 110 may transmit the second information in response to at least one of the following: receiving the DCI: transmitting an acknowledgement for the reception of the DCI: or utilizing the second set of RSs for BFD in the set of second serving cells.

In some embodiments, the terminal device 110 may terminate a second beam failure detection and recovery procedure for a second serving cell in the set of second beam failure detection and recovery procedures by at least one of the following: setting a counter configured for BFD for the second serving cell to zero: cancelling at least one BFR procedure triggered for the second serving cell: cancelling a transmission of at least one SR for the at least one BFR procedure: cancelling a reception of at least one BFRR to the at least one BFR procedure: considering a set of BFR procedures successfully completed: or considering a set of RA procedures successfully completed.

So far, the method implemented at a terminal device is described. Correspondingly, embodiments of the present disclosure also provide a method implemented at a network device. This will be described with reference to FIG. 4.

FIG. 4 illustrates a flowchart of an example method 400 of communication implemented at a network device in accordance with some embodiments of the present disclosure. The method 400 can be implemented at the network device 120 shown in FIG. 1. For the purpose of discussion, the method 400 will be described with reference to FIG. 1. It is to be understood that the method 400 may include additional acts not shown and/or may omit some shown acts, and the scope of the present disclosure is not limited in this regard.

At block 410, the network device 120 transmits, via a first serving cell (for example, the serving cell 121), DCI indicating a TCI state. In some embodiments, the network device 120 may further transmit an indication indicating that a determination is performed by a PHY layer or a MAC layer of the terminal device 110, the determination regarding that a first set of RSs for BFD in the first serving cell is reconfigured.

At block 420, the network device 120 terminates, based on the transmission of the DCI, a first beam failure detection and recovery procedure for the first serving cell. In some embodiments, the network device 120 may terminate the first beam failure detection and recovery procedure by at least one of the following: cancelling at least one BFR procedure triggered for the first serving cell: cancelling a reception of at least one SR for the at least one BFR procedure: cancelling a transmission of at least one BFRR to the at least one BFR procedure: considering a set of BFR procedures successfully completed: or considering a set of RA procedures successfully completed.

In some embodiments, the network device 120 may determine whether a common TCI state ID update and activation for CA is configured for the terminal device 110. If the common TCI state ID update and activation for CA is configured for the terminal device 110, the network device 120 may terminate a set of second beam failure detection and recovery procedures for a set of second serving cells (for example, the serving cells 122, 123 and 124) of the terminal device 110.

In some embodiments, the network device 120 may terminate a second beam failure detection and recovery procedure for a second serving cell in the set of second beam failure detection and recovery procedures by at least one of the following: cancelling at least one BFR procedure triggered for the second serving cell: cancelling a transmission of at least one SR for the at least one BFR procedure: cancelling a reception of at least one BFRR to the at least one BFR procedure: considering a set of BFR procedures successfully completed: or considering a set of RA procedures successfully completed.

It can be seen that, embodiments of the present disclosure provide a solution of communication for BFR. According to embodiments of the present disclosure, a latency of a BFR procedure for a serving cell may be reduced and signaling overhead may be saved.

### Example Implementation of Device and Apparatus

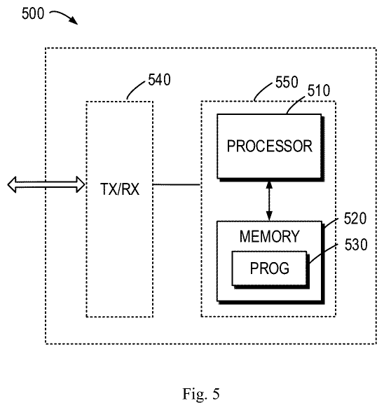

FIG. 5 is a simplified block diagram of a device 500 that is suitable for implementing embodiments of the present disclosure. The device 500 can be considered as a further example implementation of the terminal device 110 or the network device 120 as shown in FIG. 1. Accordingly, the device 500 can be implemented at or as at least a part of the terminal device 110 or the network device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises circuitry configured to: receive, via a first serving cell, DCI indicating a TCI state: determine, based on the reception of the DCI, that a first set of reference signals for beam failure detection in the first serving cell is reconfigured; and terminate, based on the determination, a first beam failure detection and recovery procedure for the first serving cell.

In some embodiments, the circuitry may be configured to perform the determination by: in accordance with a determination that the first set of reference signals for beam failure detection in the first serving cell is not configured for the terminal device, determining the first set of reference signals to include a set of reference signals for downlink channel monitoring indicated by the TCI state.

In some embodiments, the circuitry may be configured to perform the determination by: determining, by a physical layer of the terminal device and based on the DCI, that the first set of reference signals for beam failure detection in the first serving cell is reconfigured; and transmitting, from the physical layer to a medium access control layer of the terminal device, a first indication indicating that the first set of reference signals for beam failure detection in the first serving cell is reconfigured.

In some embodiments, the circuitry may be configured to perform the determination by: transmitting, from a physical layer of the terminal device to a medium access control layer of the terminal device, first information of the first set of reference signals for beam failure detection; and determining, by the medium access control layer and based on the first information, that the first set of reference signals for beam failure detection in the first serving cell is reconfigured.

In some embodiments, the circuitry may be configured to transmit the first information or the first indication in response to at least one of the following: receiving the DCI: transmitting an acknowledgement for the reception of the DCI: or utilizing the first set of reference signals for beam failure detection in the first serving cell.

In some embodiments, the circuitry may be configured to terminate the first beam failure detection and recovery procedure by at least one of the following: setting a counter configured for beam failure detection for the first serving cell to zero: cancelling at least one beam failure recovery procedure triggered for the first serving cell: cancelling a transmission of at least one scheduling request for the at least one beam failure recovery procedure: cancelling a reception of at least one beam failure recovery response to the at least one beam failure recovery procedure: considering a set of beam failure recovery procedures successfully completed: or considering a set of random access procedures successfully completed.

In some embodiments, the circuitry may be further configured to: in accordance with a determination that a common TCI state ID update and activation for CA is configured for the terminal device, determine that a second set of reference signals for beam failure detection in a set of second serving cells is reconfigured; and terminate a set of second beam failure detection and recovery procedures for the set of second serving cells.

In some embodiments, the circuitry may be configured to determine that the second set of reference signals for beam failure detection in the set of second serving cells is reconfigured by: in accordance with a determination that the second set of reference signals for beam failure detection in the set of second serving cells is not configured for the terminal device, determining the second set of reference signals to include a set of reference signals for downlink channel monitoring indicated by the TCI state.

In some embodiments, the circuitry may be configured to determine that the second set of reference signals for beam failure detection in the set of second serving cells is reconfigured by: determining, by a physical layer of the terminal device and based on the DCI and the configuration of the common TCI state ID update and activation for CA from a radio resource control layer of the terminal device, that the second set of reference signals for beam failure detection in the set of second serving cells is reconfigured; and transmitting, from the physical layer to a medium access control layer of the terminal device, a set of second indications indicating that the second set of reference signals for beam failure detection in the set of second serving cells is reconfigured. In some embodiments, the set of second indications comprises a second indication, the second indication comprising a set of identities for the set of second serving cells.

In some embodiments, the circuitry may be configured to determine that the second set of reference signals for beam failure detection in the set of second serving cells is reconfigured by: transmitting, from a physical layer of the terminal device to a medium access control layer of the terminal device, second information of the second set of reference signals for beam failure detection; and determining, by the medium access control layer and based on the second information and the configuration of the common TCI state ID update and activation for CA from a radio resource control layer of the terminal device, that the second set of reference signals for beam failure detection in the set of second serving cells is reconfigured.

In some embodiments, the circuitry may be configured to transmit the set of second indication or the second information in response to at least one of the following: receiving the DCI: transmitting an acknowledgement for the reception of the DCI: or utilizing the second set of reference signals for beam failure detection in the set of second serving cells.

In some embodiments, the circuitry may be configured to terminating a second beam failure detection and recovery procedure for a second serving cell in the set of second beam failure detection and recovery procedures by at least one of the following: setting a counter configured for beam failure detection for the second serving cell to zero: cancelling at least one beam failure recovery procedure triggered for the second serving cell: cancelling a transmission of at least one scheduling request for the at least one beam failure recovery procedure: cancelling a reception of at least one beam failure recovery response to the at least one beam failure recovery procedure: considering a set of beam failure recovery procedures successfully completed: or considering a set of random access procedures successfully completed.

In some embodiments, the circuitry may be further configured to receive an indication indicating whether the determining is performed by a physical layer or a medium access control layer of the terminal device.

In some embodiments, a network device comprises a circuitry configured to: transmit, via a first serving cell, DCI indicating a TCI state; and terminate, based on the transmission of the DCI, a first beam failure detection and recovery procedure for the first serving cell.

In some embodiments, the circuitry may be configured to terminate the first beam failure detection and recovery procedure by at least one of the following: cancelling at least one beam failure recovery procedure triggered for the first serving cell: cancelling a reception of at least one scheduling request for the at least one beam failure recovery procedure: cancelling a transmission of at least one beam failure recovery response to the at least one beam failure recovery procedure: considering a set of beam failure recovery procedures successfully completed: or considering a set of random access procedures successfully completed.

In some embodiments, the circuitry may be further configured to: in accordance with a determination that a common TCI state ID update and activation for CA is configured for the terminal device, terminating a set of second beam failure detection and recovery procedures for a set of second serving cells of the terminal device.

In some embodiments, the circuitry may be configured to terminate a second beam failure detection and recovery procedure for a second serving cell in the set of second beam failure detection and recovery procedures by at least one of the following: cancelling at least one beam failure recovery procedure triggered for the second serving cell: cancelling a transmission of at least one scheduling request for the at least one beam failure recovery procedure: cancelling a reception of at least one beam failure recovery response to the at least one beam failure recovery procedure: considering a set of beam failure recovery procedures successfully completed: or considering a set of random access procedures successfully completed.

In some embodiments, the circuitry may be further configured to transmit an indication indicating that a determination is performed by a physical layer or a medium access control layer of the terminal device, the determination regarding that a first set of reference signals for beam failure detection in the first serving cell is reconfigured.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device and via a first serving cell, downlink control information (DCI) indicating a transmission configuration indication (TCI) state:
determining, based on the DCI, that a first set of reference signals for beam failure detection in the first serving cell is reconfigured; and
terminating, based on the determination, a first beam failure detection and recovery procedure for the first serving cell.

2. The method of claim 1, wherein the determining comprises:
in accordance with a determination that the first set of reference signals for beam failure detection in the first serving cell is not configured for the terminal device, determining the first set of reference signals to include a set of reference signals for downlink channel monitoring indicated by the TCI state.

3. The method of claim 1, wherein the determining comprises:
determining, by a physical layer of the terminal device and based on the DCI, that the first set of reference signals for beam failure detection in the first serving cell is reconfigured; and
transmitting, from the physical layer to a medium access control layer of the terminal device, a first indication indicating that the first set of reference signals for beam failure detection in the first serving cell is reconfigured.

4. The method of claim 1, wherein the determining comprises:
transmitting, from a physical layer of the terminal device to a medium access control layer of the terminal device, first information of the first set of reference signals for beam failure detection; and
determining, by the medium access control layer and based on the first information, that the first set of reference signals for beam failure detection in the first serving cell is reconfigured.

5. The method of claim 3 or 4, wherein the transmitting is performed in response to at least one of the following:
receiving the DCI;
transmitting an acknowledgement for the reception of the DCI: or
utilizing the first set of reference signals for beam failure detection in the first serving cell.

6. The method of claim 1, wherein the terminating comprises at least one of the following:
setting a counter configured for beam failure detection for the first serving cell to zero:
cancelling at least one beam failure recovery procedure triggered for the first serving cell;
cancelling a transmission of at least one scheduling request for the at least one beam failure recovery procedure:
cancelling a reception of at least one beam failure recovery response to the at least one beam failure recovery procedure:
considering a set of beam failure recovery procedures successfully completed: or
considering a set of random access procedures successfully completed.

7. The method of claim 1, further comprising:
in accordance with a determination that a common TCI state identity (ID) update and activation for carrier aggregation (CA) is configured for the terminal device, determining that a second set of reference signals for beam failure detection in a set of second serving cells is reconfigured; and
terminating a set of second beam failure detection and recovery procedures for the set of second serving cells.

8. The method of claim 7, wherein determining that the second set of reference signals for beam failure detection in the set of second serving cells is reconfigured comprises:
in accordance with a determination that the second set of reference signals for beam failure detection in the set of second serving cells is not configured for the terminal device, determining the second set of reference signals to include a set of reference signals for downlink channel monitoring indicated by the TCI state.

9. The method of claim 7, wherein determining that the second set of reference signals for beam failure detection in the set of second serving cells is reconfigured comprises:
determining, by a physical layer of the terminal device and based on the DCI and the configuration of the common TCI state ID update and activation for CA from a radio resource control layer of the terminal device, that the second set of reference signals for beam failure detection in the set of second serving cells is reconfigured; and
transmitting, from the physical layer to a medium access control layer of the terminal device, a set of second indications indicating that the second set of reference signals for beam failure detection in the set of second serving cells is reconfigured.

10. The method of claim 9, wherein the set of second indications comprises a second indication, the second indication comprising a set of identities for the set of second serving cells.

11. The method of claim 7, wherein determining that the second set of reference signals for beam failure detection in the set of second serving cells is reconfigured comprises:
transmitting, from a physical layer of the terminal device to a medium access control layer of the terminal device, second information of the second set of reference signals for beam failure detection; and
determining, by the medium access control layer and based on the second information and the configuration of the common TCI state ID update and activation for CA from a radio resource control layer of the terminal device, that the second set of reference signals for beam failure detection in the set of second serving cells is reconfigured.

12. The method of claim 9 or 11, wherein the transmitting is performed in response to at least one of the following:
receiving the DCI;
transmitting an acknowledgement for the reception of the DCI; or
utilizing the second set of reference signals for beam failure detection in the set of second serving cells.

13. The method of claim 7, wherein terminating the set of second beam failure detection and recovery procedures comprises terminating a second beam failure detection and recovery procedure for a second serving cell in the set of second beam failure detection and recovery procedures by at least one of the following:
setting a counter configured for beam failure detection for the second serving cell to zero;
cancelling at least one beam failure recovery procedure triggered for the second serving cell;
cancelling a transmission of at least one scheduling request for the at least one beam failure recovery procedure;
cancelling a reception of at least one beam failure recovery response to the at least one beam failure recovery procedure;
considering a set of beam failure recovery procedures successfully completed; or considering a set of random access procedures successfully completed.

14. The method of claim 1, further comprising:
receiving an indication indicating whether the determining is performed by a physical layer or a medium access control layer of the terminal device.

15. A method of communication, comprising:
transmitting, at a network device and via a first serving cell, downlink control information (DCI) indicating a transmission configuration indication (TCI) state; and
terminating, based on the DCI, a first beam failure detection and recovery procedure for the first serving cell.

16. The method of claim 15, wherein the terminating comprises at least one of the following:
cancelling at least one beam failure recovery procedure triggered for the first serving cell;
cancelling a reception of at least one scheduling request for the at least one beam failure recovery procedure;
cancelling a transmission of at least one beam failure recovery response to the at least one beam failure recovery procedure;
considering a set of beam failure recovery procedures successfully completed; or considering a set of random access procedures successfully completed.

17. The method of claim 15, further comprising:
in accordance with a determination that a common TCI state identity (ID) update and activation for carrier aggregation (CA) is configured for the terminal device, terminating a set of second beam failure detection and recovery procedures for a set of second serving cells of the terminal device.

18. The method of claim 17, wherein terminating the set of second beam failure detection and recovery procedures comprises terminating a second beam failure detection and recovery procedure for a second serving cell in the set of second beam failure detection and recovery procedures by at least one of the following:
cancelling at least one beam failure recovery procedure triggered for the second serving cell;
cancelling a transmission of at least one scheduling request for the at least one beam failure recovery procedure;
cancelling a reception of at least one beam failure recovery response to the at least one beam failure recovery procedure;
considering a set of beam failure recovery procedures successfully completed; or considering a set of random access procedures successfully completed.

19. The method of claim 15, further comprising:
transmitting an indication indicating that a determination is performed by a physical layer or a medium access control layer of the terminal device, the determination regarding that a first set of reference signals for beam failure detection in the first serving cell is reconfigured.

20. A terminal device comprising:
a processor configured to cause the terminal device to perform the method according to any of claims 1 to 14.

21. A network device comprising:
a processor configured to cause the network device to perform the method according to any of claims 15 to 19.
